(19) United States
(12) Patent Application Publication
(10) Pub. No.: US 2022/0252231 A1
(43) Pub. Date: Aug. 11, 2022

(54) RECHARGEABLE BATTERY WITH LIGHTING

(71) Applicant: Shenzhen Oriental Willing New Energy Co., Ltd, Shenzhen (CN)

(72) Inventor: Kunli Wang, Shenzhen (CN)

(21) Appl. No.: 17/349,954

(22) Filed: Jun. 17, 2021

(30) Foreign Application Priority Data
Feb. 6, 2021 (CN) 202110165325.5

(51) Int. Cl. F21S 9/02; F21V 23/04; F21V 23/00; H01M 10/42; H01M 10/46; H01M 50/202; H01M 50/224; H01M 50/531; H01M 10/052

(52) U.S. Cl. CPC F21S 9/02; F21V 23/04; F21V 23/003; H01M 10/425; F21Y 2115/10; H01M 50/202; H01M 50/224; H01M 50/531; H01M 10/052; H01M 10/46

(57) ABSTRACT

The present disclosure provides a rechargeable battery with lighting, comprising a metal cylinder, wherein the metal cylinder includes a battery core, an insulating frame and a circuit board, the battery core has a positive electrode end and a negative electrode end, the insulating frame is provided on the positive electrode end, the circuit board is provided on the insulating frame, the negative electrode end of the battery core is conductively connected with the metal cylinder, the circuit board is provided with a charging plug, a positive electrode conductor and a negative electrode conductor are provided on the circuit board, the positive electrode conductor is conductively connected to the positive electrode end of the battery core, the negative electrode conductor is conductively connected to the metal cylinder; and the metal cylinder is provided with a lamp.

### TECHNICAL FIELD

The present disclosure relates to the technical field of a battery, and in particular to a rechargeable battery with lighting.

### BACKGROUND

A battery refers to a partial space of a cup, tank, other container or composite container containing an electrolyte solution and a metal electrode to generate electrical current, which can convert chemical energy into electrical energy and has a positive electrode and a negative electrode. With the development of science, the battery generally refers to small devices capable of generating electrical energy, such as solar cells.

Batteries are widely used in life, for example, batteries are used for various electrical appliances, now most of the batteries are disposable, that is to say, when battery capacities of the batteries are used up, the batteries cannot be reused but discarded, which not only leads to high cost of use of batteries, but also contaminates the environment caused by the discarded batteries.

With regard to the defect of battery disposable use, a rechargeable battery is available on the market in the prior art, that is to say, when the battery capacity is used up, the battery can be charged by an external power supply. Therefore, the rechargeable battery can be reused. However, the rechargeable battery in the prior art has a complex structure and a single function.

### SUMMARY

An objective of embodiments of the present disclosure is to provide a rechargeable battery with lighting, which aims to solve the complex structure and the single function of the rechargeable battery in the prior art.

One embodiment of the present disclosure provides a rechargeable battery with lighting, comprising a metal cylinder, wherein a cavity is arranged in the metal cylinder, a core body is arranged in the cavity; the core body includes a battery core, an insulating frame and a circuit board, the battery core has a positive electrode end and a negative electrode end, the insulating frame is provided on the positive electrode end, the circuit board is provided on the insulating frame, the negative electrode end of the battery core is conductively connected with the metal cylinder, the circuit board is provided with a charging plug, which has a charging socket exposed on an outer surface of the metal cylinder; a positive electrode conductor and a negative electrode conductor are provided on the circuit board, the positive electrode conductor is conductively connected to the positive electrode end of the battery core and is exposed on an upper end of the metal cylinder, the negative electrode conductor is conductively connected to the metal cylinder; and the upper end of the metal cylinder is provided with a lamp, which is respectively conductively connected to the positive electrode end and the negative electrode end of the battery core and has a conductive connector inserted into the charging socket.

Preferably, the lamp comprises a lamp plate and a lamp holder arranged on the upper end of the metal cylinder, the lamp plate is conductively connected to the conductive connector, a plurality of LEDs are arranged on the lamp plate, and a lamp cover is covered on the lamp plate; the lamp plate and the lamp cover are arranged on the lamp holder respectively, a side of the lamp holder is provided with a bump arranged outside the metal cylinder, the bump is provided with a switch for controlling the lamp, and the conductive connector is protruded at an inside of the bump.

Preferably, the lamp plate is conductively connected with the positive electrode conductor, and the conductive connector is inserted into the charging socket to conductively connected with the negative electrode end of the battery core.

Preferably, the lamp plate and the positive electrode conductor are arranged separately, and the conductive connector is inserted into the charging socket to conductively connected with the negative electrode end and the positive electrode end of the battery core respectively.

Preferably, the negative electrode conductor has a ring sheet shape, surrounds an outer circumference of the positive electrode conductor and is insulated from the positive electrode conductor, and an outer circumference of the negative electrode conductor is fixedly butted against and connected with the metal cylinder.

Preferably, the positive electrode conductor has a cylindrical shape, an upper end of the positive electrode conductor extends above the circuit board, and a lower end of the positive electrode conductor extends below the circuit board, passes through an insulator and is conductively connected with the positive electrode end of the battery core.

Preferably, a conductive spring is provided between the lower end of the positive electrode conductor and the positive electrode end of the battery core; a plurality of balancing springs are provided between the insulating frame and an upper end of the battery core, and a plurality of balancing springs are arranged at intervals along a circumferential direction of the insulating frame.

Preferably, a protective pad is provided on the circuit board, and the protective pad has a notched ring shape and is arranged in a surrounding area of the positive electrode conductor and the negative electrode conductor.

Preferably, the insulating frame is provided with a groove for containing the circuit board, the charging plug is arranged on a side of the circuit board, an upper part of the charging plug protrudes above the circuit board, a lower part of the charging plug protrudes below the circuit board, the charging socket is exposed outside the circuit board; a notch groove communicated with the groove is provided on a side of the insulating frame, and the charging plug is embedded into the notch groove.

Preferably, the upper end of the metal cylinder is provided with a cavity opening communicated with the cavity, an upper end of the positive electrode conductor extends out of the cavity opening; and an upper end of a side wall of the metal cylinder extends toward the cavity opening to form a pressure ring, which presses against the negative electrode conductor from top to bottom.

Compared with the prior art, the present disclosure provides a rechargeable battery with lighting, wherein a battery core is provided in a metal cylinder, a positive electrode end of the battery core is conductively connected with a positive electrode conductor on a circuit board, the positive electrode conductor is exposed outside the metal cylinder; a negative electrode end of the battery core is conductively connected with the metal cylinder, and a negative electrode conductor on the circuit board is conductively connected with the metal cylinder, so as to facilitate the circuit board to conductively connect with the positive electrode end and the negative electrode end of the battery core respectively. Therefore, the present disclosure has the advantage of simple structure and realizes external charging directly through a charging plug on the circuit board, and a lamp is provided on the metal cylinder, which can provide a lighting function, so that the battery has various functions.

### BRIEF DESCRIPTION OF THE DRAWINGS

In order to more clearly illustrate the technical solutions in the embodiments of the present disclosure, drawings used in the description of the embodiments will be briefly described below, obviously, the drawings in the following description are some embodiments of the present disclosure, those of ordinary skill in the art can also obtain other drawings based on these drawings without any creative efforts.

FIG. 1 is a perspective view of a rechargeable battery with lighting provided by the embodiment of the present disclosure.

FIG. 2 is a perspective view of a part of a rechargeable battery with lighting provided by the embodiment of the present disclosure.

FIG. 3 is a perspective view of another part of a rechargeable battery with lighting provided by the embodiment of the present disclosure.

FIG. 4 is a circuit schematic diagram of rechargeable battery with lighting provided by the embodiment of the present disclosure.

### DESCRIPTION OF THE EMBODIMENTS

To make the objective, technical solutions and advantages of the present disclosure clearer and more comprehensible, the present disclosure will be further described in detail below with reference to the drawings and the embodiments. It should be understood that the specific embodiments described herein are only used to explain the disclosure and are not used to limit the disclosure.

The implementation of the present disclosure will be described in detail in combination with specific embodiments.

It is to be noted that when an element is described as “fixed on” or “provided on” another element, it may be directly or indirectly on the another element. When one element is described as “connected to” another element, it may be directly or indirectly connected to the another element.

The same or similar reference signs in the drawings of the present embodiment correspond to the same or similar components; in the description of the present disclosure, it should be understood that if there is an orientation or positional relationship indicated by terms “upper”, “lower”, “left”, “right”, etc., the orientation or positional relationship is based on the orientation or positional relationship shown in the drawings, and is only for the convenience of describing the present disclosure and simplifying the description, rather than indicating or implying that the indicated device or element must have a specific orientation or be constructed and operated in a specific orientation. Therefore, the terms describing the positional relationship shown in the drawings are only for exemplary description, and cannot be understood as a limitation of the present disclosure. For those of ordinary skill in the art, the specific meaning of the above terms can be understood according to the specific circumstances.

In addition, terms “first” and “second” are merely for the purpose of description, but cannot be understood as the indication or implication of relative importance or as the implicit indication of the number of the designated technical features. Therefore, features defined by “first” and “second” may explicitly or implicitly include one or more such features. In the description of the present disclosure, unless otherwise clearly and specific stated, “a plurality of” means two or more than two.

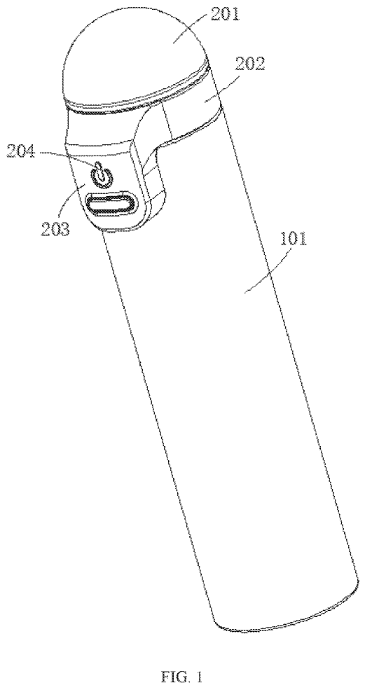

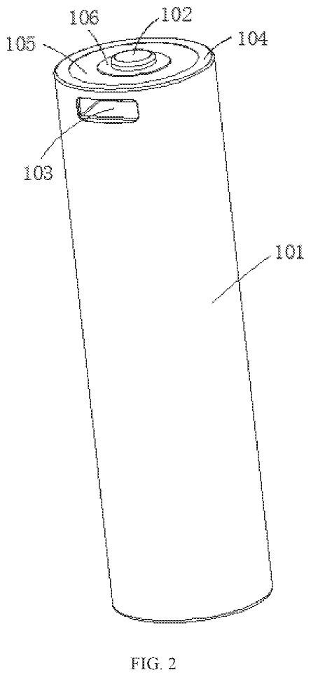

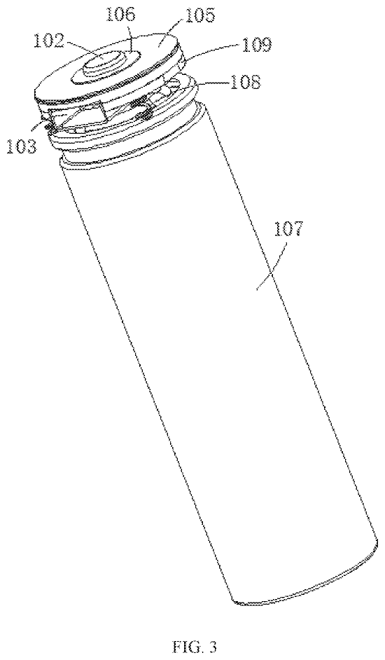

Referring to FIGS. 1 to 3, a preferred embodiment of the present disclosure is provided.

A rechargeable battery with lighting, comprising a metal cylinder 101, the metal cylinder 101 may be made up of a steel material, which not only has good wear resistance but also good conductivity, or the metal cylinder 101 may also be made up of other metal and alloy materials with good conductivity.

A cavity is arranged in the metal cylinder 101, and a core body is arranged in the cavity; the core body includes a battery core 107, an insulating frame and a circuit board 109, wherein the battery core 107 may be an existing lithium battery core, the battery core 107 is commonly used in daily energy storage objects such as power banks, and is a main component that stores and discharges electric energy.

The battery core 107 is provided in the metal cylinder 101 and closely fits with the metal cylinder 101. The battery core 107 has a positive electrode end and a negative electrode end, the insulating frame is provided on the positive electrode end, the circuit board 109 is provided on the insulating frame, and the negative electrode end of the battery core 107 is conductively connected with the metal cylinder 101. A positive electrode conductor 102 and a negative electrode conductor are provided on the circuit board 109, the positive electrode conductor 102 is conductively connected to the positive electrode end of the battery core 107 and is exposed on an upper end of the metal cylinder 101, the negative electrode conductor is conductively connected to the metal cylinder 101, in such a way that instead of using a conductor such as a wire, the circuit board 109 is respectively conductively connected with the positive electrode conductor 102 and the negative electrode conductor, which can reduce unusable conditions caused by failures such as desoldering.

The insulating frame not only functions to isolate the battery core 107 from the circuit board 109, mainly to prevent short-circuit contact between the positive electrode conductor 102 and the negative electrode conductor of the battery, but also to surround and protect the circuit board 109. In addition, the battery core 107, the insulating frame and the circuit board 109 are stacked together to form a relatively stable fixing and supporting function and to enhance an impact resistance of a whole consisting of the battery core 107, the insulating frame and the circuit board 109 stacked together.

The circuit board 109 is provided with a charging plug 103, which has a charging socket exposed on an outer surface of the metal cylinder 101, in such a way that when a battery capacity of the battery core 107 is used up, the charging plug 103 can be connected with an external power supply through a data cable, so as to realize charging the battery core 107. The upper end of the metal cylinder 101 is provided with a lamp, which is respectively conductively connected to the positive electrode end and the negative electrode end of the battery core 107 and has a conductive connector inserted into the charging socket. When the lamp needs to be removed, the conductive connector is pulled out of the charging socket. Therefore, the battery can also be used for lighting, that is, the battery capacity of the battery core 107 is used to provide electric energy to the lamp so as to realize the lighting effect.

In the rechargeable battery with lighting provided by the above embodiment, the battery core 107 is provided in the metal cylinder 101, the positive electrode end of the battery core 107 is conductively connected with the positive electrode conductor 102 on the circuit board 109, the positive electrode conductor 102 is exposed outside the metal cylinder 101; the negative electrode end of the battery core 107 is conductively connected with the metal cylinder 101, and the negative electrode conductor on the circuit board 109 is conductively connected with the metal cylinder 101, so as to facilitate the circuit board 109 to conductively connect with the positive electrode end and the negative electrode end of the battery core 107 respectively. Therefore, the present disclosure has an advantage of simple structure and can realize external charging directly through the charging plug 103 on the circuit board 109, and the lamp is provided on the metal cylinder 101, which can provide the lighting function, so that the battery has various functions.

In the present embodiment, the conductive connector and the charging socket cooperate with each other and may be various types of connectors, such as type-C connector, iPhone charging connector or micro USB connector, etc.

The lamp comprises a lamp plate arranged on the upper end of the metal cylinder 101, the lamp plate is conductively connected to the positive electrode conductor 102 and the negative electrode conductor respectively, a plurality of light emitting diodes (LEDs) are arranged on the lamp plate, and a lamp cover 201 is covered on the lamp plate. The positive electrode conductor 102 and the negative electrode conductor are both arranged on the circuit board 109, so as to facilitate the lamp plate to conductively connect with the battery core 107.

The lamp comprises a lamp holder 202, the lamp plate and the lamp cover 201 are arranged on the lamp holder 202, a side of the lamp holder 202 is provided with a bump 203, which is arranged outside the metal cylinder 101, and the bump 203 is provided with a switch 204 for controlling the lamp to turn on/off, and the conductive connector is protruded at an inside of the bump, so as to facilitate the conductive connector to be inserted into the charging socket. The lamp holder 202 is provided to facilitate the assembly the lamp in the metal cylinder 101.

The bump 203 is arranged along an axial direction of the metal cylinder 101 and has a strip shape, so as to facilitate the arrangement of the bump 203 and the user to control and operate the switch 204 on the bump 203.

In the present embodiment, the lamp plate is conductively connected with the positive electrode conductor 102, and the conductive connector is inserted into the charging socket to conductively connected with the negative electrode end of the battery core 107, in such a way that the lamp plate is conductively connected with the positive electrode end and the negative electrode end of the battery core 107, so as to the lamp plate is conductively connected with the battery core 107.

Alternatively, the lamp plate and the positive electrode conductor 102 are arranged separately, and the conductive connector is inserted into the charging socket to conductively connected with the negative electrode end and the positive electrode end of the battery core 107 respectively. The charging socket can be configured in various shapes according to the actual needs.

In the present embodiment, the lamp holder 202 is fixedly arranged on the upper end of the metal cylinder 101. The lamp holder 202 and the upper end of the metal cylinder 101 can be fixedly arranged in a variety of ways. A bottom of the lamp holder 202 is provided with an installation groove with an opening at the lower part, the upper end of the metal cylinder 101 is directly embedded in the installation groove, so as to realize the detachable installation between the upper end of the metal cylinder 101 and the lamp holder 202. Alternatively, the installation between the lamp holder 202 and the metal cylinder 101 may be in other ways, and are not limited to the present embodiment.

The negative electrode conductor has a ring sheet shape, surrounds an outer circumference of the positive electrode conductor 102 and is insulated from the positive electrode conductor 102, and an outer circumference of the negative electrode conductor is fixedly butted against and connected with the metal cylinder 101. The negative electrode conductor has a ring sheet shape, so as to facilitate the negative electrode conductor to be arranged on the circuit board 109, which can save space, and to facilitate the negative electrode conductor to conductively connect with the metal cylinder 101, which can avoid the phenomenon of conductively disconnection.

The positive electrode conductor 102 has a cylindrical shape, an upper end of the positive electrode conductor 102 extends above the circuit board 109, and a lower end of the positive electrode conductor 102 extends below the circuit board 109, passes through an insulator and is conductively connected with the positive electrode end of the battery core 107. The positive electrode conductor 102 has a cylindrical shape, so as to facilitate the extension of the positive electrode conductor 102.

A conductive spring is provided between the lower end of the positive electrode conductor 102 and the positive electrode end of the battery core 107. Alternatively, the lower end of the positive electrode conductor 102 may also be conductively connected with the positive electrode end of the battery core 107 through a conductor such as a nickel belt, a pinner, an elastic sheet and a copper particle, without welding connection through wires, which improves the reliability of the connection, and avoids unusable conditions such as desoldering. Alternatively, the lower end of the positive electrode conductor 102 may be directly butted against and connected with the positive electrode end of the battery core 107, and the specific implementation depends on the actual situation.

In the present embodiment, the lower end of the positive electrode conductor 102 is provided with a fixed slot, and an upper end of the conductive spring is embedded in the fixed slot to ensure the stability of the butted connection between the conductive spring and the positive electrode conductor 102. A lower end of the conductive spring is sleeved on an outer circumference of the positive electrode end of the battery core 107 and is butted against and connected with the positive electrode end of the battery core 107. Alternatively, the conductive spring can be connected in many other ways, which is determined according to the actual needs.

A plurality of balancing springs 108 are provided between the insulating frame and an upper end of the battery core 107, and a plurality of balancing springs 108 are arranged at intervals along a circumferential direction of the insulating frame, which enhances the stability of the connection between the insulating frame and the battery core 107, and the balancing springs 108 play a role of buffering and balancing when the battery is damaged by collision or other external factors.

A protective pad 106 is provided on the circuit board 109, and the protective pad 106 has a notched ring shape and is arranged in a surrounding area of the positive electrode conductor 102 and the negative electrode conductor. The protective pad 106 can protect an uncovered part of the circuit board 109 to prevent the circuit board 109 from being damaged by objects.

A surface pad 105 is covered on the circuit board 109, the surface pad 105 has a ring shape and has a central hole in a center of which, and the upper end of the positive electrode conductor 102 passes through the central hole of the surface pad 105. The surface pad 105 presses against the negative electrode conductor and the circuit board 109 from top to bottom. The protective pad 106 is arranged in the central hole of the surface pad 105, and is arranged flush with the surface pad 105, and an outer circumference of the protective pad 106 is butted against and connected with an inner circumference of the surface pad 105. The surface pad 105 is made up of Polyethylene terephthalate (PET) or paper.

The insulating frame is provided with a groove for containing the circuit board 109, the charging plug 103 is arranged on a side of the circuit board 109, an upper part of the charging plug 103 protrudes above the circuit board 109, the insulating frame presses against the upper part of the charging plug 103 from top to bottom, a lower part of the charging plug 103 protrudes below the circuit board 109, and the charging socket is exposed outside the circuit board 109; a notch groove communicated with the groove is provided on a side of the insulating frame, and the charging plug 103 is embedded into the notch groove.

The upper end of the metal cylinder 101 is provided with a cavity opening communicated with the cavity, and the upper end of the positive electrode conductor 102 extends out of the cavity opening; an upper end of a side wall of the metal cylinder 101 extends toward the cavity opening to form a pressure ring 104, which presses against the negative electrode conductor from top to bottom. Thus, the battery core 107, the insulating frame and the circuit board 109 can form an overall stable structure through the pressure action of the pressure ring 104.

In the present embodiment, the lower end of the metal cylinder 101 can be closed or provided with a lower end opening, in such a way that the negative electrode end of the battery core 107 can also be exposed through the lower end opening.

An outer film is sleeved outside the metal cylinder 101, and the outer film can protect the metal cylinder 101.

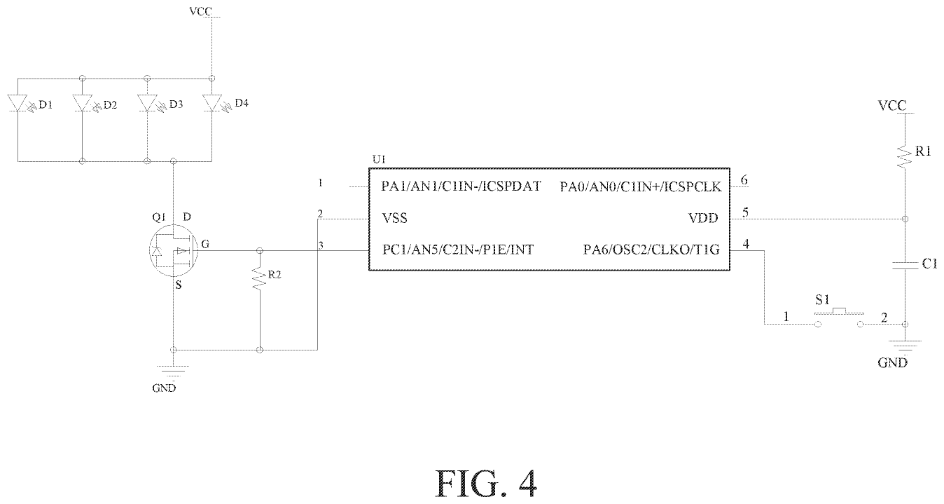

FIG. 4 is a circuit schematic diagram of rechargeable battery with lighting provided by the embodiment of the present disclosure. As shown in FIG. 4, the lamp plate is provided with a plurality of LEDs and an integrated control chip, and a plurality of LEDs are electrically connected with the integrated control chip. The integrated control chip comprises a MCU U1, a MOS transistor (Metal Oxide Semiconductor transistor) Q1, the first resistor R1, the second resistor R2, a capacitor C1 and a switch S1.

A VDD end (the fifth pin) of the MCU U1 is electrically connected to one end of the first resistor R1, and the other end of the first resistor R1 is electrically connected to an external power supply VCC; the VDD end of the MCU U1 is also electrically connected to one end of the first capacitor C1, and the other end of the first capacitor C1 is grounded.

A PA6/OSC2/CLKO/T1G end (the fourth pin) of the MCU U1 is electrically connected to one end of the switch S1, and the other end of the switch S1 is grounded.

A PC1/AN5/C2IN−/P1E/INT end (the third pin) of the MCU U1 is electrically connected with one end of the second resistance R2, and the other end of the second resistance R2 is grounded; the PC1/AN5/C2IN−/P1E/INT end of the MCU U1 is also electrically connected to a gate of the MOS transistor Q1, a drain of the MOS transistor Q1 is electrically connected to a negative electrode of one LED or two or more LEDs electrically connected in parallel (the FIG. 4 shows a situation of four LEDs D1, D2, D3 and D4 electrically connected in parallel), a positive electrode of one LED or two or more LEDs electrically connected in parallel is electrically connected to the external power supply VCC, and a source of the MOS transistor Q1 is grounded.

A VSS end (the second pin) of the MCU U1 is grounded.

The working principle of the rechargeable battery with lighting provided by the present disclosure is: the MCU U1 outputs PWM (pulse width modulation) waveform by detecting a on/off state of the switch S1, and controls the conduction and disconduction of the MOS transistor Q1, so as to control a current flowing through one LED or two or more LEDs electrically connected in parallel, and a current intensity represents a brightness of the LED, and the stronger the current is, the brighter the LED is.

The embodiments described above are merely preferred embodiments of the present disclosure, are not intended to limit the present disclosure, and any modification, equivalent substitution and improvement made within the principle of the present disclosure should be included in the protection scope of the present disclosure.

1. A rechargeable battery with lighting, comprising a metal cylinder, wherein
a cavity is arranged in the metal cylinder, a core body is arranged in the cavity;
the core body includes a battery core, an insulating frame and a circuit board, the battery core has a positive electrode end and a negative electrode end, the insulating frame is provided on the positive electrode end, the circuit board is provided on the insulating frame, the negative electrode end of the battery core is conductively connected with the metal cylinder, the circuit board is provided with a charging plug, which has a charging socket exposed on an outer surface of the metal cylinder;
a positive electrode conductor and a negative electrode conductor are provided on the circuit board, the positive electrode conductor is conductively connected to the positive electrode end of the battery core and is exposed on an upper end of the metal cylinder, the negative electrode conductor is conductively connected to the metal cylinder;
a conductive spring is provided between the lower end of the positive electrode conductor and the positive electrode end of the battery core;
a plurality of balancing springs is provided between the insulating frame and an upper end of the battery core, and the plurality of balancing springs is arranged at intervals along a circumferential direction of the insulating frame;
the upper end of the metal cylinder is provided with a lamp, which is respectively conductively connected to the positive electrode end and the negative electrode end of the battery core, and has a conductive connector inserted into the charging socket.

2. The rechargeable battery with lighting of claim 1, wherein the lamp comprises a lamp plate and a lamp holder arranged on the upper end of the metal cylinder, the lamp plate is conductively connected to the conductive connector, a plurality of LEDs are arranged on the lamp plate, and a lamp cover is covered on the lamp plate; the lamp plate and the lamp cover are arranged on the lamp holder respectively, a side of the lamp holder is provided with a bump arranged outside the metal cylinder, the bump is provided with a switch for controlling the lamp, and the conductive connector is protruded at an inside of the bump.

3. The rechargeable battery with lighting of claim 2, wherein the lamp plate is conductively connected with the positive electrode conductor, and the conductive connector is inserted into the charging socket to conductively connected with the negative electrode end of the battery core.

4. The rechargeable battery with lighting of claim 2, wherein the lamp plate and the positive electrode conductor are arranged separately, and the conductive connector is inserted into the charging socket to conductively connected with the negative electrode end and the positive electrode end of the battery core respectively.

5. The rechargeable battery with lighting of claim 1, wherein the negative electrode conductor has a ring sheet shape, surrounds an outer circumference of the positive electrode conductor and is insulated from the positive electrode conductor, and an outer circumference of the negative electrode conductor is fixedly butted against and connected with the metal cylinder.

6. The rechargeable battery with lighting of claim 1, wherein the positive electrode conductor has a cylindrical shape, an upper end of the positive electrode conductor extends above the circuit board, and a lower end of the positive electrode conductor extends below the circuit board, passes through an insulator and is conductively connected with the positive electrode end of the battery core.

7. (canceled)

8. The rechargeable battery with lighting of claim 5, wherein a protective pad is provided on the circuit board, and the protective pad has a notched ring shape and is arranged in a surrounding area of the positive electrode conductor and the negative electrode conductor.

9. The rechargeable battery with lighting of claim 1, wherein the insulating frame is provided with a groove for containing the circuit board, the charging plug is arranged on a side of the circuit board, an upper part of the charging plug protrudes above the circuit board, a lower part of the charging plug protrudes below the circuit board, the charging socket is exposed outside the circuit board; a notch groove communicated with the groove is provided on a side of the insulating frame, and the charging plug is embedded into the notch groove.

10. The rechargeable battery with lighting of claim 5, wherein the upper end of the metal cylinder is provided with a cavity opening communicated with the cavity, an upper end of the positive electrode conductor extends out of the cavity opening; and an upper end of a side wall of the metal cylinder extends toward the cavity opening to form a pressure ring, which presses against the negative electrode conductor from top to bottom.

11. The rechargeable battery with lighting of claim 2, wherein the lamp plate is provided with an integrated control chip, the integrated control chip comprises a MCU (microcontroller unit), a MOS (metal oxide semiconductor) transistor, a first resistor, a second resistor, a capacitor and a switch;
the MCU outputs PWM (pulse width modulation) waveform by detecting a on/off state of the switch S1, and controls a conduction and disconduction of the MOS transistor Q1, so as to control a current flowing through one LED or two or more LEDs electrically connected in parallel.

12. (canceled)

13. (canceled)

14. (canceled)
